(19) United States
(12) Patent Application Publication
(10) Pub. No.: US 2024/0182636 A1
(43) Pub. Date: Jun. 6, 2024

(54) MODIFIED POLYLACTONES USEFUL FOR FATLIQUORING

(71) Applicant: TFL Ledertechnik GmbH, Rheinfelden (DE)

(72) Inventors: Eric KIENTZ, Ferrette (FR); Nebojcha DJOKIC, Pulversheim (FR)

(73) Assignee: TFL Ledertechnik GmbH, Rheinfelden (DE)

(21) Appl. No.: 18/555,170

(22) PCT Filed: Apr. 13, 2022
(86) PCT No.: PCT/EP2022/059919

§ 371 Date: Oct. 12, 2023

(30) Foreign Application Priority Data
Apr. 15, 2021 (EP) 21168715.7

(51) Int. Cl. C08G 63/91; C08G 63/08; C08G 63/82; C08L 67/04; C14C 3/06; C14C 3/14; C14C 3/28; C14C 9/02

(52) U.S. Cl. CPC C08G 63/912; C08G 63/08; C08G 63/823; C08L 67/04; C14C 3/06; C14C 3/14; C14C 3/28; C14C 9/02

(57) ABSTRACT

Modified polylactones, aqueous compositions including them, as well as their use and methods including their use as fatliquoring agents (“fatliquors”) in the treatment of leathers, including other embodiments.

This application is a 35 U.S.C. § 371 national stage of international application PCT/EP2022/059919, which was filed Apr. 12, 2022, is titled “MODIFIED POLYLACTONES USEFUL FOR FATLIQUORING,” and claims priority to EP 21168715.7, which was filed Apr. 15, 2021, both of which are incorporated herein by reference.

### FIELD

The invention relates to modified polylactones, aqueous compositions comprising them, as well as their use and methods comprising there use as fatliquoring agents (“fatliquors”) in the treatment of leathers, including other invention embodiments as disclosed below.

### BACKGROUND

Several compositions have been used in order to provide fatliquoring during the manufacture of leathers. Leather, after tannage, often does not contain sufficient softening components, so that during drying they would dry into a brittle and undesirable mass with insufficient flexibility that may be prone to cracking under stress.

Fatliquoring is a process of introducing an oily, hydrophobic component (e.g., an oil or fat) into a skin following tannage but normally before the tanned skin is dried. It involves applying water-dispersable (e.g., as emulsions or suspensions) “oils” to leather, sometimes including addition of a fat-soluble dye. This contributes the required softness and flexibility to the leather.

Fatliquoring can also contribute to the hydrophobing of leather, thus making the resultant leather less susceptible to water.

Various materials have been used for fatliquoring, among them mineral oils, waxes, natural (e.g. animal or plant) oils and fats.

In addition to these, chemically modified or synthesised material, that is, partially or completely synthetic polymeric materials, occasionally based on raw materials from renewable resources, have been employed for fatliquoring. For example, WO 2015/107148 A1 discloses fatliquoring emulsions based on polymeric fatlike materials (“polymeric fat”) that may include fatty acids, natural and/or synthetic glyceride oils or natural and/or synthetic fatty esters and are otherwise based on a chemical reaction product of glycol polymer and maleic acid previously reacted with a fatty alcohol or a fatty alcohol ethoxylate or a fatty acid ethoxylate or a fatty amine ethoxylate also including a sulfonation and/or sulfitation and/or salification. WO 2017/081710 A1 also provides glycol polymer based fatliquoring compositions and also includes optional phosphatation. Neither of these two documents provides actual examples of synthesis and use of the compounds and compositions claimed.

An issue with such materials and the leathers obtained with fatliquoring agents is that they often comprise fractions or activate components in leathers that volatilize and then may lead to emission of organic compounds that may, for example in the use in closed rooms or cars, lead to “fogging”. This refers to the deposition of material on walls and windows and leads to a dirty appearance and/or opacity. Polyethylenglykols may also contain traces of ethylene oxide and 1,4-Dioxane, two CMR substances (A. Wala-Jerzykiewicz et al., Chem. Anal, 41, 253, (1996), Analysis of Free Oxirane and 1,4-Dioxane Contents in the Ethoxylated Surface-Active Compounds by Means of Gas Chromatography with Headspace Sample Injection) and cause unnecessary health issues, e.g. allergy.

U.S. Pat. No. 5,618,911 discloses certain “biodegradable” modified lactone polymers prepared by reaction of an oligomer from &-caprolactone and lactic acid and a mixture containing stearic acid and the like, for use as biodegradable plastic, not suggesting any relationship to tanning and leather.

There remains the problem of providing novel fatliquoring compositions and chemicals that show good properties and that especially allow to reduce VOCs and fogging, and to provide fatliquoring agents that at least allow to dispense with the presence of polyethylene or polypropylene glycols if desired.

### SUMMARY

Specific objectives of present invention are to provide a fatliquor oligomer or polymer allowing for obtaining:
leather with good softness and tightness as well as good mechanical strength and/or
leather with good fastness properties like heat and UV yellowing resistance and/or
leather having low emission as shown by fogging test according EN ISO 17071: September 2006 (method A reflectance and method B gravimetric) and/or VOC/FOG values according VDA278 thermal desorption analysis of organic emissions for the characterization of non-metallic materials for automobile, October 2011 and/or
low COD (chemical oxygen demand) value in the exhausted bath after retanning and fatliquoring steps indicating high fixation in leather.
enhanced biodegradation and composting properties.

### DETAILED DESCRIPTION

It has been found that, surprisingly, the present invention, by including lactone oligomers or polymers (also referred to as polylactone herein) as backbone components instead of or in addition to polyethylene glycol, allows to obtain fatliquoring agents that show lower emission of volatile organic compounds (VOCs) and semi volatile fogging compounds (FOG) from the leather treated with them, especially lower fogging compounds, when compared with comparable compounds wherein instead of the polylactone moieties only polyethylene glycol moieties are present. In certain embodiments polyalkylene glycols can be avoided. The obtained fatliquoring compositions show good storage ε stability and they have a biodegradable and compostable polymeric backbone (S. Kliem et al, Materials, 2020, 13, 4586).

Although most of C4-C12 lactones like δ-valerolactone and ε-caprolactone are prepared industrially from petrol, some of them may be also obtained from biomass feedstocks. For example, δ-valerolactone can be biosynthetized from pentose sugars via furfural and ε-caprolactone from fructose via hydroxymethyl furfural (see Buntara, T. et al, Caprolactam from renewable resources: Catalytic conversion of 5-hydroxymethylfurfural into caprolactone. Angew. Chem. Int. Ed. 2011, 50, 7083-7087). Renewable lactones like δ-decalactone and ε-decalactone obtained from castor oil via fungal action have attracted growing attention for the preparation of new random or block copolymers (see S. Thongkham et al, Simple In-Based Dual Catalyst Enables Significant Progress in ε-Decalactone Ring-Opening (Co)polymerization, Macromolecules 2019, 52, 21, 8103-8113).

Most of natural occurring lactones like coumarin, tetronic acid or a-alkylidene-lactones are not suitable biobased monomers for polyester synthesis (see Y. Jiang et al, Polymers, 2016, 8, 243).

Leathers fatliquored according to the invention have good fullness, good softness and tightness. Fastness properties like fogging resistance, heat yellowing and emission of volatiles are also at least comparable or improved.

Specifically, it has been surprisingly found that with the oligomer and polymer composition based on polylactone polyester, and especially those based on (especially ε-) caprolactone polyester, all properties described above can be easily fulfilled, emission values are improved compared to products from state of the art or commercial polymeric fatliquor compositions.

It has been also established that when a lactone polymer, preferably a caprolactone polymer having functionality of at least 3 is used the resulting dispersion of the invention remain liquid at temperature lower than 5° C. In other terms, the undesirable formation of solids, e.g., by crystallization, can be avoided.

It was also found that leather inner softness can be adjusted by mixing the polymer according the invention with sulphited or sulphated oils like for example rapeseed oil. By mixing with a silicone oil fogging reflectometric value can be significantly improved.

The compounds especially fulfil the REACH conditions for polymers: The statutory regulation conditions are laid down by the Chemicals or “REACH” Directive (Directive (EC) No. 1907/2006) in Europe. Polymers according to the invention have a molecular weight distribution such that no single molecule species is present in a proportion of more than 50% by weight and at the same time more than 50% by weight of the chains are composed of at least 3n+1 covalently bonded monomer units.

A first embodiment of the invention relates to modified (especially C4-C12-, preferably capro-) lactone polymers in the sense of the REACH definition that are obtainable by
reacting, in the presence of a catalytic Lewis or (preferably) Brønstedt acid reagent, a (especially C4-C12-, preferably capro-) lactone oligomer or polymer (both referred to herein as (preferably capro-) lactone polymer), said lactone polymer least one hydroxy or amino group and at least one carboxyl having (A) at least two hydroxy or two amino groups or two carboxyl groups or (B) at group or (C) at least one hydroxy group and one amino group, with at least,
(1) optionally with preceding reaction of an ethylenically unsaturated C4-C8 dicarboxylic anhydride, an alkyl or alkylene C12-C40 acid or alcohol which is linear or branched, free or ethoxylated and/or propoxylated; an alkyl or alkylene C12-C22 primary or secondary amine that is linear or branched and is ethoxylated or not; a fatty C36 dimer or C54 trimer acid or alcohol or amine; a hydroxylated C12-C20 acid; or a fatty acid ester of glycerol, carrying hydroxyl or not; or two or more of these reactants; and optionally with branched alkyl C4-C10 alcohol (preferred) or acid (preferred) or amine and/or (preferred) a polydimethylsiloxane with carboxylic or hydroxyl or amine end and/or side groups;
where the product of step (1) is then when carrying
(a) no carboxyl group but at least one hydroxyl and/or amino group, or
(b) at least one carboxyl group and at least one hydroxyl and/or amino group, respectively, in case of (a) mandatorily, in case of (b) optionally (but preferably),
(2) further reacted (i) with ethylenically unsaturated C4-C8 dicarboxylic anhydride or (ii) with phosphorus pentoxide P2O5 or phosphoric acid or polyphosphoric acid; where
(3) in the case of reacting with ethylenically unsaturated C4-C8 dicarboxylic anhydride, such as maleic anhydride or itaconic anhydride, the polymer of step 1 and/or step (2) is mandatorily, or where the polymer comprises at least one carboxyl group optionally (but preferably), further reacted with (i) metabisulphite or bisulphite or sulphite or sulfuric acid or (ii) a mixture of two or more thereof.

For the products according to the invention and the corresponding aqueous compositions and preferably also the fatliquors as such as described within the description and claims the following proviso is given: The modified lactone polymer end product is,
where when starting from a lactone polymer (B) having one hydroxy and one carboxyl,
and where no preceding reaction with an ethylenically unsaturated C4-C8 dicarboxylic anhydride is performed,
in the case where only an alkyl or alkylene C12-C40 acid is reacted in step (1) or in the case where an alkyl or alkylene C12-C40 acid and an alkylene C12-C40 alcohol are reacted in step (1), respectively,
other than the product of said lactone polymer (B) having resulted from ring opening with lactic acid. This compound type as such is thus excluded from the (remaining scope of) modified lactone polymers of the invention. This proviso is, however, preferably not included in the definition of the use for fatliquoring and the process for fatliquoring according to the invention where also such modified lactone polymers may be used.

If required, after neutralization by a base, the resulting modified (especially capro-) lactone polymer is dispersed into water resulting in an aqueous dispersion.

The dispersion (also called fatliquor herein) can be used as fatliquor as such or as a composition which may further comprise (i) sulphited or sulphated oil like rapeseed oil, fish oil, sunflower oil, soybean oil, linseed oil, cottonseed oil or palm oil, (ii) a mixture of two or more of them; or (iii) a silicone like a polydimethylsiloxane oil or a reactive functional siloxane or a low molecular weight siloxane.

The following definitions serve to define preferred meanings of more general expressions and features used herein, where in each invention embodiment one, more than one or all general expressions or features can be replaced by the more specific expressions or features, thus forming and disclosing specific embodiments of the invention, each of which is also to be regarded as included here as invention embodiment.

“Moreover” means that features characterized by this word may be of lower preference than the other features without this attribute.

“Comprising”, “including”, “with” or “containing” means that the features (which includes the term components) or list of features attributed with these words or other grammatical forms thereof are non-limiting features (other features may be present). “Consisting of” or “consist(s) of” refers to a closed (conclusive, exhaustive) list of features and excludes the presence of other features. In preferred variants of the non-limiting feature lists, “comprising”, “including”, “with” or “containing”, or their grammatical analogues, can be replaced with “consisting of” or “consist(s) of”.

Where “about” is mentioned, this preferably means that the numeric value to which this is added can vary by ±20%, more preferably by ±10%, yet more preferably by ±5%, and most preferably “about” where used can be deleted.

“And/or” means that the features/substances mentioned can in each case be present on their own or in a combination of two or more of the particular features/substances mentioned.

Where “a” or “an” is mentioned, this is to be understood in particular to refer to the indefinite article, and it includes “one or more”.

The modified lactone polymers of the present invention, in any embodiments mentioned above or below, preferably have molecular weights, determined by Gel Permeation Chromatography (GPC) as described in detail in the Examples, with average molecular weight (Mw) in the range from 400 to 10000 or to 9000, e.g. from 500 to 9000, for example from 1000 to 6000.

A catalytic Lewis or Brønstedt acid reagent catalyses substitution by an OH, NH or COOH group, thus effectively working as a catalyst. Examples of Lewis or Brønstedt acid-catalysts are para-toluene sulfonic acid, methane sulfonic acid, trifluoromethane sulfonic acid, sulfuric acid or hydrochloric acid; or metal salts, such as salts of iron, aluminium, bismuth, calcium, magnesium, tin, titanium, zinc, lanthanides or rare earth metals, where the anions are preferably organic acid carboxylate anions, such as acetate, octoate, isooctanoate ethylhexanoate, neodecanoate, acetalacetonate, naphthenate or quinolate, or anions from organic acids, such as chloride or sulfate. Mixtures of two or more such reagents are possible.

A first embodiment of the invention relates to modified (especially C4-C12-, preferably capro-) lactone polymers in the sense of the REACH definition that are obtainable by the reactions mentioned above or below.

The terms (preferably capro-) lactone or (preferably capro-) lactone oligomers or polymers preferably refer to C4-C12 lactones, especially to (therefore the “preferably”) caprolactone oligomers or polymers (which more generally are also referred to as (preferably capro-) lactone polymers. Wherever “lactone polymer(s)” are mentioned, this stands for “(preferably capro) lactone oligomers or polymers”.

The (preferably capro-)lactone oligomer or polymer starting materials, both referred to herein also as “(preferably capro-) lactone polymer”, in the reactions described herein includes the product of a ring opening polymerization (ROP) of an (especially C4-C12-, preferably capro-) lactone monomer initiated with an initiator like a di- or polyol, a di- or polyacid, a di- or polyamine or molecules having different reactive groups like hydroxyl, carboxyl or amine in the presence of a catalyst (e.g. a catalytic Lewis or Brønstedt acid reagent, especially as defined above) or a lipase at a temperature from 20° C. to 200° C.

Where the lactone polymerization is initiated with a di- or polyol, or a di or polyamine, the final polymer will be hydroxyl terminated, while when initiated with a di- or polyacid, the resulting polymer will be carboxyl terminated.

The reactions to obtain the final modified lactone polymers are preferably conducted so as to ensure that in each step at least on average about one mol (e.g. 1±0.5, such as 1±0.2 mol) hydroxy, carboxy and/or amino group is modified per mol of such group in each of the reaction steps i.e. in case of a triol lactone polymer, two moles of hydroxy can be reacted with a fatty acid or a mixture of fatty acids (step 1) followed in the next step (step 2) of reaction of one mole of hydroxy with maleic anhydride or itaconic anhydride. Another example is reacting a triol polymer lactone with one mole fatty acid (step 1) followed in the next step (step two) of reaction of two moles of maleic anhydride or itaconic anhydride Among the lactone oligomer or polymer (both referred to as lactone polymer) educts, those carrying one or more hydroxy and/or carboxyl groups, and/or further one or more amino groups, are preferred.

The production of polycaprolactone via ring opening polymerization is well described in U.S. Pat. No. 7,622,547B2.

Amino terminated lactone polymers can be obtained by further reacting a carboxyl terminated lactone polymer with an amine or polyamine like hexamethylenediamine, for example as described in patent EP1809684B1.

Preferred lactone monomers that can be used for ring opening polymerization are C4-C12 lactones like γ-butyrolactone, δ-valerolactone, ε-caprolactone or renewable lactones like δ-decalactone and ε-decalactone. The preferred lactone for making the inventive fatliquors is δ-valerolactone and/or (in particular) ε-caprolactone.

A di- or polyol initiator preferably only carries primary hydroxy groups, e.g., terminal hydroxymethyl or hydroxyethyl groups (with two hydrogen atoms in the methyl part) or moreover other types of hydroxy groups showing similar or especially identical reactivity towards nucleophilic substitution. Examples of di- or polyols are ethyleneglycol, higher diols carrying two terminal hydroxy groups, such as propan-1,3-diol,2,2-dimethylpropane-1,3-diol, or butan-1,4-diol, hexane-1,6-diol or high molecular diols like Ymer N120 or Tegomer D3403 having molecular weight of 1200 g/mol and capped side chain of ethylene oxide with 20-25 moles EO or (especially) triols, such as trimethylolpropane or tris(hdroxyethyl)amine, tetrahydroxy compounds, such as pentaerythritol, ditrimethylolpropane or N,N,N′,N′-Tetrakis-(2-hydroxyethyl)-ethylendiamin, or moreover sugar alcohols, such as glycerol, erythritol, threitol, arabitol, xylitol, ribitol, mannitol, sorbitol, galactitol, fucitol, iditol or inositol, or fatty esters of glycerol or sorbitan like glycerol monostearate, glycerol isostearate, sorbitan monostearate (SPAN 60) or polyethylene glycol sorbitan monostearate (TWEEN 60), or polyglycerol or polyglycerol esters of fatty acids. Triols and their products are preferred.

A di- or polyacid initiator preferably only carries primary carboxy groups, e.g. terminal carboxymethyl or carboxyethyl groups (with two hydrogen atoms in the methyl part) or moreover other types of carboxy groups showing similar or especially identical reactivity towards nucleophilic substitution. Examples of di- or polyacids are maleic acid, fumaric acid, itaconic acid, succinic acid, adipic acid, azelaic acid, sebacic acid, propane-1,2,3-tricarboxylic acid, butane-1,2,4-tricarboxylic acid.

Examples of di or polyamine as initiators are ethylenediamine, 1,3-diaminopropane, hexamethylene-1,6-diamine, diethylenetriamine, tris(2-aminoethyl)amine or tris(3-aminopropyl)amine.

Examples of molecules having hydroxyl and/or carboxyl and/or amine reactive groups comprise at least two different or all three different groups selected from hydroxy, carboxyl and amino, and are preferably glyceric acid, glycolic acid, tartaric acid, malic acid, dimethylolpropinoic acid, citric acid, isocitric acid, or amino acids like aspartic acid, alanine, valine, or serine see J. Liu et al, Macromolecules 2004, 37(8), 2674-2676.

Preferred catalysts used in the ROP of lactones are selected from but not limited to: Aluminium (III) isopropoxide, Tin(II) 2-ethylhexanoate, monobutyltin oxide, dibutyltin oxide, bismuth zinc catalyst mixtures described in U.S. Pat. No. 7,799,874 B2 like a) bismuth ethylhexanoate and ethylhexanoic acid, b) bismuth ethylhexanoate and bismuth neodecanoate or c)zinc oxide and zinc neodecanoate, and organic acids like methane sulfonic acid, para-toluene sulfonic acid or trifluoromethane sulfonic acid. ROP of lactone can also be obtained in the presence of enzymes like lipase, (see, for example, Albertsson A.-C. et al, Recent developments in enzyme-catalyzed ring-opening polymerization, Advanced Drug Delivery Reviews, 2008, 60, 1077).

An alkyl or alkylene C12-C40 acid or alcohol, all of them being linear or branched, ethoxylated and/or propoxylated, preferably is an acid or alkanol with 12 to 40 carbon atoms, such as stearic acid, tridecanoic acid, tetradecanois acid, pentadecanoic acid, hexadecenoic acid, heptadecanois acid, or octadecanoic acid or dodecanol, tridecanol, tetradecanol, pentadecanol, hexadecanol, heptadecanol or octadecanol, or the like, and can preferably be ethoxylated and/or propoxylated at an OH or —COOH, so that a free OH group is at the terminal ethoxylene or propoxylene group. Preferably, the number of ethoxylene and/or propoxylene groups per such moiety is in the range of (on average) 2 to 50, e.g., 2 to 30, such as 2 to 12.

An alkyl or alkylene C12-C22 primary or secondary amine that is linear or branched and is ethoxylated or not preferably is an alkyl with a primary amino or a N—C1-C12-alkylamino, such as methylamino or ethylamino, group, such as dodecylamine, tridecylamine, tetradecylamine, pentadecylamine, hexadecylamine, or N-methyl- or N-ethyl-(dodecylamine, tridecylamine, tetradecylamine, pentadecyl-amine, hexadecylamine), and can be ethoxylated or propoxylated at the primary or secondary amino group, so that a free OH group is at the terminal ethoxylene or propoxyene group. Preferably, the number of ethoxylene and/or propoxylene groups per such moiety is in the range of (on average) 2 to 50, e.g., 2 to 30, such as 2 to 12.

A fatty C36 dimer or C54 trimer acid or alcohol or amine preferably is the product from two or three unsaturated fatty acids that are cyclized and carry two or three carboxyl groups, which can be replaced by OH or amino groups.

Examples of unsaturated dimer alcohols are RADIANOL 1990 from OLEON and PRIPOL 2030, or PRIPOL 2033 from CRODA.

Examples of unsaturated C36 dimer acids derived from rapeseed fatty acids distilled or not or hydrogenated are RADIACID 0950, RADIACID 0951, RADIACID 0955, RADIACID 0960, RADIACID 0970, RADIACID 0972, RADIACID 0975 from OLEON, PRIPOL 1006, 1009, 1010, 1025 (H), PRINOL 1012, 1013 or 1098 (NH) from CRODA, UNIDYM 18 or UNIDYM 22 from KRATON or C54 trimer acid like RADIACID 0982 or RADIACID 0983 from OLEON, PRIPOL 1040 or PROPOL 1045 from CRODA or a composition of C36 dicarboxylic or C54 tricarboxylic fatty acids like UNIDYM M15 or M35 from KRATON.

Examples of dimer fatty amines are PRIAMINE 1071, PRIAMINE 1073, PRIMAINE 1074 and PRIMAINE 1075 from CRODA.

A hydroxylated C12-C20 acid can carry one or two or more primary or preferably secondary hydroxyl groups, and it can be saturated (preferred), unsaturated, and can be linear or branched. Examples are 2-hydroxytetradecanoic acid, 3-hydroxydecanoic acid, 3-hydroxy-13-methyltetradecanoic acid, 2-hydroxyhexadecanoic acid, 3-hydroxyhexadecanoic acid, 3-hydroxy-15-methylhexadecanoic acid, 3-hydroxyoctadecanoic acid, 17-hydroxyoctadecanoic acid, or mixtures thereof.

A fatty acid ester of glycerol, carrying hydroxyl or not (i.e., optionally with a hydroxyl), can be a mono-, di- or triester of glycerol with, e.g., a C8-C40 fatty acid or a hydroxylated C12-C20 acid, e.g., as defined in the preceding paragraph. This hydroxyl can be a remaining free hydroxyl on the glycerol part of the molecule and/or a hydroxyl on a hydroxylated C12-C20 acid.

A branched alkyl C4-C10 alcohol can, for example, be isobutanol, 2-methyl-1-butanol, 3-methyl-1-butanol or the like. A corresponding acid or amine carries a carboxyl or an amino group (primary or secondary, in the latter case, e.g., methylamino or ethylamino).

A polydimethylsiloxane with carboxylic or hydroxyl or amine end or side groups preferably has two or more, e.g., up to 20, Si—O units and can carry one, two or more, e.g., up to 3, carboxyl, hydroxyl or (primary or moreover secondary) amino groups; it is, for example, a dicarboxylic end group polydimethylsiloxane with a molecular weight from about 300 to about 5000 g/mol, e.g., from about 2500 to about 3500 g/mol.

An example of an appropriate reactive polysiloxane with carboxyl single end group is X-22-3710 with MW of 1450 g/mol from SHIN ETSU, and an example of a reactive polysiloxane with dual carboxyl end groups is TEGOTEX RT1010 from EVONIK, HANSA LPF 710, 7162 from CHT, or X-22-162C with MW of 4600 g/mol from SHIN ETSU.

An example of a reactive polysiloxane with primary hydroxyl single end group is X-22-170BX with MW of 2800 g/mol from SHIN ETSU or SILMER OH A0 with MW of 300 g/mol from SILTECH, and an example of a reactive polysiloxane with dual primary hydroxyl end groups is HANSA OS 4017 with molecular weight of 950 g/mol or HANSA OS 4035 with 2000 g/mol from CHT, BAYSILONE OF-OH702 4% having a MW of 850 g/mol or BAYSILONE OF-OH 702E with 2240 g/mol from MOMENTIVE, KF-6000 with 935 g/mol or KF-6001 with 1800 g/mol from SHIN ETSU, SILMER OH Di-10 and SILMER OH Di-50 with MW of 1000 g/mol and 4000 g/mol respectively, or SILMER OHT-A0 a hydroxyalkyl siloxane with MW 400 g/mol all from SILTECH.

An ethylenically unsaturated C4-C8 dicarboxylic anhydride preferably is maleic anhydride (cis-but-2-enediocic acid anhydride), especially its cyclic internal anhydride, or (especially biobased) itaconic anhydride (3-methylideneoxolane-2,5-dione).

While many different (preferably capro-) lactone polymers are commercially available, or can be synthetized by a person skilled in the art according the methods described above, also the remaining starting materials are commercially available or accessible by standard reactions known to the person skilled in the art.

A preferred variant of the preceding or subsequent reactions resulting in modified lactone polymers includes the preceding ROP as described above.

The reactions preferably are led as follows:

Reaction (1) is conducted, optionally with preceding reaction with the ethylenically unsaturated C4-C8 dicarboxylic anhydride at a temperature in in the range from about 60 to 140° C., e.g. at about 80 to 110° C., preferably in a molar ratio of 1 to 0.1 to 5, relating to the mole of hydroxyl groups or amine groups in the (preferably capro-)lactone polymer and the mole of dicarboxylic acid, respectively, in the presence of one or more of the starting materials (other than the acid anhydride) mentioned under (1) at an elevated temperature, preferably from about 80 to about 160° C., e.g. from about 120 to 140 about ° C., such as about 130° C., where the reaction is started and accelerated by the presence of a catalytic Lewis or Brønstedt acid reagent as described above, e.g. in amounts from about 0.1 to about 5 mol-%, such as from about 0.2 to about 2 mol-%, relative to the molar amount of the poly(preferably capro-) lactone and starting material and by removal of water from the (preferably capro-) lactone polymer and starting mixture, e.g., by vacuum distillation.

The subsequent reaction (2) is, in the case of reaction with an ethylenically unsaturated C4-C8 dicarboxylic acid anhydride, done under similar conditions and catalysis as described for the optional reaction under (1) above, preferably after removal of water from the starting mixture, e.g., by vacuum distillation, to preferably bring water content down to 0.05 wt % or less based on total mixture

The reaction with phosphorus pentoxide and/or phosphoric acid or polyphosphoric acid preferably takes place at a temperature between about 40 to about 120° C., e.g., from about 50 to about 100° C., with a preferred molar ratio of hydroxyl or amino groups in the educt from the preceding step to phosphor reactant from about 1 to 0.1 to 5, e.g. from 0.2 to 3, during, e.g., from 1 to 5 h followed by neutralization of the mixture with a base, such as ammonia, a alkali metal hydroxide, such as sodium hydroxide, an organic amine, such as triethylamine, diethanolamine, triethanolamine or monoethanolamine, preferably followed by dispersion into water resulting in an aqueous dispersion having from 20% to 80% solid content and PH from 4 to 9.

The reaction with metabisulphite or bisulphite or sulphite or sulfuric acid, a sulphation, is preferably conducted with an alkaline metal metabisulfite, sulfite or bisulfite, or ammonium bisulfite, or gaseous sulfite anhydride in a molar ration of 1 to 0.5 to 2, preferably about 1 to 1, at a preferred temperature from about 50 to about 100° C., preferably from 50 to 80° C., with water being present.

After neutralization by a base, e.g., one as mentioned in the second to last preceding paragraph, the resulting modified (preferably capro-) lactone polymer is dispersed into water resulting in an aqueous dispersion with similar properties as described in the preceding paragraph.

The dispersion is a special invention embodiment—it is a composition for fatliquoring. It can be used as fatliquor as such or as a modified composition which may further comprise, e.g., (i) sulphited or sulphated oil like rapeseed oil, fish oil, sunflower oil, soybean oil, linseed oil, cottonseed oil or palm oil, (ii) a mixture of two or more of them; or (iii) a silicone like a polydimethylsiloxane oil, or a carboxyl reactive functional siloxane as described above.

The following are preferred embodiments of the invention:

In an embodiment (A*) of the invention, the invention relates to modified lactone polymers having (A) at least two hydroxy or two amino groups or two carboxyl groups or (B) at least one hydroxy or amino group and at least one carboxyl group or (C) at least one hydroxy group and one amino group, obtainable by
reacting, in the presence of a catalytic Lewis or Brønstedt acid reagent, a lactone oligomer or polymer—both referred to herein as lactone polymer—with at least
(1)—optionally with preceding reaction of an ethylenically unsaturated C4-C8 dicarboxylic anhydride—an alkyl or alkylene C12-C40 acid or alcohol, all of them being linear or branched, free or ethoxylated and/or propoxylated; an alkyl or alkylene C12-C22 primary or secondary amine that is linear or branched and is ethoxylated or not; a fatty C36 dimer or C54 trimer acid or alcohol or amine; a hydroxylated C12-C20 acid; or a fatty acid ester of glycerol, carrying hydroxyl or not; or two or more of these reactants; and optionally with branched alkyl C4-C10 alcohol or acid or amine and/or a polydimethylsiloxane with carboxylic or hydroxyl or amine end and/or side groups; where the product of step (1) when carrying (a) no carboxyl group but at least one hydroxyl and/or amino group, or
(b) at least one carboxyl group and at least one hydroxyl and/or amino group, respectively,
in case of (a) mandatorily, in case of (b) optionally (but preferably),
(2) further reacted (i) with ethylenically unsaturated C4-C8 dicarboxylic anhydride or (ii) with phosphorus pentoxide, phosphoric acid or polyphosphoric acid, or a mixture thereof;
where
(3) in the case of reacting with ethylenically unsaturated C4-C8 dicarboxylic anhydride, such as maleic anhydride or itaconic anhydride, the polymer of step 1 and/or step (2) (i) is—where the polymer comprises at least one carboxyl group optionally—further reacted with metabisulphite, bisulphite, sulphite or sulfuric acid, or (ii) a mixture of two or more thereof;
   with the proviso that the modified lactone polymer is,
   where when starting from a lactone polymer (B) having one hydroxy and one carboxyl,
   and where no preceding reaction with an ethylenically unsaturated C4-C8 dicarboxylic anhydride is performed,
   in the case where only an alkyl or alkylene C12-C40 acid is reacted in step (1) or in the case where an alkyl or alkylene C12-C40 acid and an alkylene C12-C40 alcohol are reacted in step (1), respectively,
   other than the product of said lactone polymer (B) having resulted from ring opening with lactic acid.

An embodiment (B*) of the invention relates to modified lactone polymers according to embodiment (A*) in the form of an aqueous dispersion, obtained by dispersion of modified lactone polymers of claim 1 in water, optionally with or after neutralization by a base.

An embodiment (C*) of the invention relates to modified lactone polymers according to embodiment (A*) or (B*), obtained by
reacting, in the presence of a catalytic Lewis or (preferably) Brønstedt acid reagent, a lactone oligomer or polymer—
(1*)—optionally with preceding reaction of maleic or itaconic acid anhydride—with an alkyl or alkylene C12-C40 acid or alcohol that is free or ethoxylated and/or propoxylated and optionally with a polydimethylsiloxane with carboxylic or hydroxyl end and/or side groups;
where the product of step (1*) when carrying
(a) no carboxyl group but at least one hydroxyl and/or amino group, or
(b) at least one carboxyl group and at least one hydroxyl and/or amino group, respectively,
in case of (a) mandatorily, in case of (b) optionally (but preferably),
(2*) is further reacted with maleic or itaconic acid anhydride;
where
(3*) in the case of reacting with maleic or itaconic acid anhydride, the polymer of step (1*) and/or step (2*) is optionally further reacted with (i) metabisulphite, bisulphite, sulphite or sulfuric acid, or (ii) a mixture of two or more thereof;
followed by optional dispersion of the modified lactone polymers in water, optionally with or after neutralization by a base;
   preferably with the proviso that the modified lactone polymer is,
   where when starting from a lactone polymer (B) having one hydroxy and one carboxyl,
   and where no preceding reaction with an ethylenically unsaturated C4-C8 dicarboxylic anhydride is performed,
   in the case where only an alkyl or alkylene C12-C40 acid is reacted in step (1) or in the case where an alkyl or alkylene C12-C40 acid and an alkylene C12-C40 alcohol are reacted in step (1), respectively,
   other than the product of said lactone polymer (B) having resulted from ring opening with lactic acid.

An embodiment (D*1) of the invention relates to the modified lactone polymers or dispersion thereof according to any one of embodiments (A*) to (C*), where the anhydride is maleic acid anhydride; and/or the lactone oligomer or polymer is the reaction product of a lactone monomer with a di- or polyol initiator that carries primary hydroxy groups, e.g. terminal hydroxymethyl, especially propan-1,3-diol, butan-1,4-diol, trimethylolpropane, tris(hdroxyethyl)amine, pentaerythritol or N,N,N′,N′-Tetrakis-(2-hydroxyethyl)-ethylendiamine;

An embodiment (D*2) of the invention relates to the modified lactone polymers or dispersion thereof according to any one of embodiments (A*) to (C*), where the lactone oligomer or polymer is the reaction product of a lactone monomer with a di- or polyamine initiator that carries primary amine groups, e.g. ethylenediamine, 1,3-diaminopropane, hexamethylene-1,6-diamine, diethylenetriamine, tris(2-aminoethyl)amine or tris(3-aminopropyl)amine.

An embodiment (D*3) of the invention relates to the modified lactone polymers or dispersion thereof according to any one of embodiments (A*) to (C*), where the lactone oligomer or polymer is the reaction product of a lactone monomer with a di- or polyacid initiator that carries primary carboxyl groups, e.g. maleic acid, fumaric acid, itaconic acid, succinic acid, adipic acid, azelaic acid, sebacic acid, propane-1,2,3-tricarboxylic acid, butane-1,2,4-tricarboxylic acid.

An embodiment (D*4) of the invention relates to the modified lactone polymers or dispersion thereof according to any one of embodiments (A*) to (C*), where the carboxylic lactone oligomer or polymer (D*3) is further reacted with a diamine or polyamine e.g. ethylenediamine, 1,3-diaminopropane, hexamethylene-1,6-diamine, diethylenetriamine, tris(2-aminoethyl)amine or tris(3-aminopropyl)amine.

An embodiment (E*) of the invention relates to the modified lactone polymers or dispersion thereof according to any one of embodiments (A*) to (D*4), where the anhydride is maleic acid anhydride; and/or the lactone oligomer or polymer is a C4-C12 lactone oligomer or polymer, especially a δ-valerolactone and/or an ε-caprolactone oligomer or polymer, preferably not comprising a lactic acid moiety.

An embodiment (F*) of the invention relates to an aqueous composition comprising component (A**),
wherein (A**) comprises products (A**1), (A**2) or (A**3), or a mixture of two or all of them,
wherein
(A**1) is the reaction product of a lactone oligomer or polymer having (A) at least two hydroxy or two amino groups or two carboxyl groups or (B) at least one hydroxy or amino group and at least one carboxyl group or (C) at least one hydroxy group and one amino group, optionally after preceding reaction of an ethylenically unsaturated C4-C8 dicarboxylic anhydride, with an alkyl or alkylene C12-C40 acid or alcohol which is linear or branched, free or ethoxylated and/or propoxylated; an alkyl or alkylene C12-C22 primary or secondary amine that is linear or branched and is ethoxylated or not; a fatty C36 dimer or C54 trimer acid or alcohol or amine; a hydroxylated C12-C20 acid; or a fatty acid ester of glycerol, carrying hydroxyl or not; or two or more of these reactants; and optionally with branched alkyl C4-C10 alcohol or acid or amine and/or a polydimethylsiloxane with carboxylic or hydroxyl or amine end and/or side groups;
(A**2) is the reaction product of (A**1) where said product has then when carrying
(a) no carboxyl group but at least one hydroxyl and/or amino group, or
(b) at least one carboxyl group and at least one hydroxyl and/or amino group, respectively,
in case of (a) mandatorily, in case of (b) optionally (but preferably), been further reacted with (i) an ethylenically unsaturated C4-C8 dicarboxylic anhydride or (ii) with phosphorus pentoxide, phosphoric acid or polyphosphoric acid, or a mixture thereof; and
(A**3) is the reaction product of (A**1) or (A**2) when reacted with an ethylenically unsaturated C4-C8 dicarboxylic anhydride and then—where the polymer comprises at least one carboxyl group optionally (but preferably)—further reacted with metabisulphite, bisulphite, sulphite or sulfuric acid, or a mixture of two or more thereof;
where the pH of the product is optionally adjusted to a pH of 5 to 10, especially 6 to 9;
   preferably (especially if the pH has not been adjusted as just described) with the proviso that the modified lactone polymer is,
   where when starting from a lactone polymer (B) having one hydroxy and one carboxyl,
   and where no preceding reaction with an ethylenically unsaturated C4-C8 dicarboxylic anhydride is performed,
   in the case where only an alkyl or alkylene C12-C40 acid is reacted in step (1) or in the case where an alkyl or alkylene C12-C40 acid and an alkylene C12-C40 alcohol are reacted in step (1), respectively,
   other than the product of said lactone polymer (B) having resulted from ring opening with lactic acid.

An embodiment (G*) of the invention relates to the aqueous composition according to embodiment (F*), wherein
(A**1 is the reaction product of the lactone oligomer or polymer with an alkyl or alkylene C12-C40 acid or alcohol that is free or ethoxylated and/or propoxylated, and optionally with a polydimethylsiloxane with carboxylic or hydroxyl end and/or side groups; —optionally after a preceding reaction of maleic or itaconic acid anhydride—
(A**2) is the reaction product of (A**1), which when carrying
(a) no carboxyl group but at least one hydroxyl and/or one amino group, or
(b) at least one carboxyl group and at least one hydroxyl and/or amino group, respectively,
in case of (a) mandatorily, in case of (b) optionally (but preferably) has been reacted with an ethylenically unsaturated C4-C8 dicarboxylic anhydride; and
(A**3) is the reaction product of (A**1) or (A**2), if reacted with ethylenically unsaturated C4-C8 dicarboxylic acid, especially maleic or itaconic acid anhydride, further reacted with metabisulphite, bisulphite, sulphite or sulfuric acid, or a mixture of two or more thereof;
followed by optional dispersion of the modified lactone polymers in water, optionally with or after neutralization by a base to a pH of 5 to 10, preferably 6 to 9;
   preferably (especially if the pH has not been adjusted as just described) with the proviso that the modified lactone polymer is,
   where when starting from a lactone polymer (B) having one hydroxy and one carboxyl,
   and where no preceding reaction with an ethylenically unsaturated C4-C8 dicarboxylic anhydride is performed,
   in the case where only an alkyl or alkylene C12-C40 acid is reacted in step (1) or in the case where an alkyl or alkylene C12-C40 acid and an alkylene C12-C40 alcohol are reacted in step (1), respectively,
   other than the product of said lactone polymer (B) having resulted from ring opening with lactic acid.

An embodiment (H*1) of the invention relates to the aqueous composition according to any one of embodiments (F*) or (G*), wherein the anhydride is maleic acid anhydride; and/or the lactone oligomer or polymer is the reaction product of δ-valerolactone or ε-caprolactone with a di- or polyol initiator that carries primary hydroxy groups, e.g. terminal hydroxymethyl, especially propan-1,3-diol, butan-1,4-diol, trimethylolpropane (preferred), tris(hdroxyethyl)amine, pentaerythritol or N,N,N′,N′-Tetrakis-(2-hydroxyethyl)-ethylenediamine; and/or the alkyl or alkylene C12-C40 acid are preferably selected from stearic acid, tridecanoic acid, tetradecanoic acid, pentadecanoic acid, hexadecenoic acid, heptadecanoic acid and octadecanoic acid, and can preferably be ethoxylated and/or propoxylated at an OH; and/or the pH of the product is preferably adjusted to a pH of 5 to 10, especially 6 to 9.

An embodiment (H*2) of the invention relates to the aqueous composition according to any one of embodiments (F*) or (G*), wherein the anhydride is maleic acid anhydride; and/or the lactone oligomer or polymer is the reaction product of δ-valerolactone or ε-caprolactone with a di- or polyamine initiator that carries primary amine groups, e.g. ethylenediamine, 1,3-diaminopropane, hexamethylene-1,6-diamine, diethylenetriamine, tris(2-aminoethyl)amine or tris(3-aminopropyl)amine and/or the alkyl or alkylene C12-C40 acid are preferably selected from stearic acid, tridecanoic acid, tetradecanoic acid, pentadecanoic acid, hexadecenoic acid, heptadecanoic acid, octadecanoic acid, and can preferably be ethoxylated and/or propoxylated at an OH or —COOH; and/or the pH of the product is preferably adjusted to a pH of 5 to 10, especially 6 to 9.

An embodiment (H*3) of the invention relates to the aqueous composition according to any one of embodiments (F*) or (G*), wherein the lactone oligomer or polymer is the reaction product of 8-valerolactone or 8-caprolactone with a di- or polyacid initiator that carries primary carboxyl groups, e.g.
maleic acid, fumaric acid, itaconic acid, succinic acid, adipic acid, azelaic acid, sebacic acid, propane-1,2,3-tricarboxylic acid, butane-1,2,4-tricarboxylic acid and/or the alkyl or alkylene C12-C40 alcohol are preferably selected from dodecanol, tridecanol, tetradecanol, pentadecanol, hexadecanol, heptadecanol or octadecanol, and can preferably be ethoxylated and/or propoxylated at an OH or —COOH; and/or the pH of the product is preferably adjusted to a pH of 5 to 10, especially 6 to 9.

An embodiment (H*4) of the invention relates to the aqueous composition according to any one of embodiments (F*) or (G*), wherein the lactone oligomer or polymer is the reaction product of δ-valerolactone or ε-caprolactone with a di- or polyacid initiator that carries primary carboxyl groups, further reacted with a diamine or polyamine e.g. ethylenediamine, 1,3-diaminopropane, hexamethylene-1,6-diamine, diethylenetriamine, tris(2-aminoethyl)amine or tris(3-aminopropyl)amine and/or the alkyl or alkylene C12-C40 acid are preferably selected from stearic acid, tridecanoic acid, tetradecanoic acid, pentadecanoic acid, hexadecenoic acid, heptadecanoic acid, octadecanoic acid, and can preferably be ethoxylated and/or propoxylated at an OH or —COOH; and/or the pH of the product is preferably adjusted to a pH of 5 to 10, especially 6 to 9.

An embodiment (I*) of the invention relates to the aqueous compositions according to any one of embodiments (F*) to (H*4), where the anhydride is maleic acid anhydride; and/or the lactone oligomer or polymer is a C4-C12 lactone oligomer or polymer, especially a δ-valerolactone and/or an ε-caprolactone oligomer or polymer, preferably obtained by a ROP with a diol, triol, tetrol or moreover other polyol.

An embodiment (J*) according to the invention relates to a fatliquor for the treatment of leather, comprising a modified lactone polymer according to any one of embodiments (A*) to (E*) or an aqueous composition according to any one of embodiments (F*) to (I*) and one or more additives for stabilizing, coloring, softening, hydrophobization, conservation and/or other conditioning.

An embodiment (K*) of the invention relates to the fatliquor according to embodiment (J*), comprising an agent selected from the group consisting of phenol sulfonic syntan, acrylic polymer solution or dispersion, a sulphited or sulphated oil like rapeseed oil, fish oil, sunflower oil, soybean oil, linseed oil, cottonseed oil or palm oil, a mixture of two or more of them; and a silicone, especially a polydimethylsiloxane oil or a polydimethylsiloxane emulsion or a reactive functional siloxane or a low molecular weight siloxane.

An embodiment (L*) of the invention relates to the use of a modified lactone polymer according to any one of embodiments (A*) to (E*), an aqueous composition according to any one of embodiments (F*) to (I*), or a fatliquor according to embodiment (J*) or (K*), for fatliquoring of a skin or leather.

An embodiment (M*) of the invention relates to the use according to embodiment (L*), where the leather is a chrome and/or vegetable and/or aldehyde tanned leather.

An embodiment (N*) of the invention relates to a process for fatliquoring a skin or leather, comprising administering a modified lactone polymer according to any one of embodiments (A*) to (E*), an aqueous composition according to any one of embodiments (F*) to (I*) or a fatliquor according to embodiment (J*) or (K*)—any of them referred to also as fatliquoring agent—to said skin or leather in the presence of water and if desired further agents and treating the resulting aqueous mixture, optionally in the presence of further additives, at an elevated temperature, e.g. from 30 to 80° C., such as at about 50° C.; wherein preferably the fatliquoring is done after washing and rechroming the skin or leather and retanning at a pH in the range of 3 to 5, preferably about 4, followed by the fatliquoring with addition of the fatliquoring agent in an amount of 2 to 20, preferably 4 to 10, weight percent based on solid content, preferably including a final fixation, e.g., in the presence of an organic acid, such as formic acid, and washing with water and preferably then drying the obtained leather.

An embodiment (O*) refers to a leather obtainable by a manufacture comprising the process according to any one of embodiments (L*) to (M*).

An embodiment (P*) refers to a process for the manufacture of a fatliquoring agent, comprising the process steps mentioned in any one of embodiments (A*) to (E*) or (F*) to (I*).

Preferred embodiments of the invention are shown in the claims, with particular embodiments in the dependent claims; the claims are to be regarded as part of the present description.

Highly preferred embodiments of the invention are formed by selecting the starting materials and products obtained as mentioned in the examples, without the other limiting details (e.g., reaction temperatures, molar ratios, pH values) provided in the Examples.

The following Examples serve to illustrate the invention without limiting the scope thereof, however, they also form specific invention embodiments:

### Comparative Example Polymer A

A 1.5 liters reactor equipped with a thermometer, agitator and a cooling column connected to a vacuum pump was charged with 172.41 g (0.43 mole) of polyethylene glycol (PEG400 with on average 9 ethoxy (EO) units) and 122.63 g (0.43 mole) of stearic acid and heated up to 120° C. When the temperature was reached, 1.48 g (0.009 mole) of para-toluenesulfonic acid monohydrate was added to the reactor and the temperature was increased to 160° C. The reactor was kept for 1 h at 160° C., then vacuum was applied to the reactor and water was distilled off during 2 hours. Final acid value of the mixture was found to be 3.2 mg KOH/g.

The temperature was then reduced to 105° C. and the reactor was charged first with 176.25 g (0.43 mole) of a fatty alcohol polyethyleneglycol ether, based on iso-decanol and on average 5.5 ethylene oxide units (BIODAC 510 from Sasol S.p.A.) and then at 75° C. with 42.28 g (0.43 mole) of maleic anhydride. Another charge of para-toluenesulfonic acid monohydrate of 56 g (0.009 mole) was added to the reactor and the temperature was then increased to 160° C. Water was distilled off under vacuum during 9 hours. Final acid value was found to be 6.48 mg KOH/g. A sample was taken for GPC measurement in THF using a polystyrene calibration curve. Number molecular weight Mn was 1150 g/mol and average molecular weight Mw 2473 g/mol.

The reactor containing the polymer was cooled down to 80-85° C. and sulfitation was initiated by feeding into the reactor within 30 minutes a solution having pH 7.0 of 220.00 g of city (=tap) water, 41.00 g (0.216 mole) of sodium metabisulfite and 24.70 g of 50% sodium hydroxide. After addition of the solution, the reactor was kept 2 h 30 min at 80-85° C. The reactor was cooled down by adding 250.0 g of tap water.

A dark brown cloudy dispersion was obtained having a final solids content of 54% and a PH of 7.2.

Upon cooling at 20° C., the polymer dispersion became solid. Diluted to 35% solids after being heated up for 1 h at 65° C., the polymer dispersion became again solid after cooling at 20° C.

### Comparative Example Polymer B

A 1.5 liters reactor equipped with a thermometer, agitator and a cooling column connected to a vacuum pump was charged with 172.41 g (0.43 mole) of polyethylene glycol (PEG400 with on average 9 EO units and 122.63 g (0.43 mole) of stearic acid and heated up to 95° C. When the temperature was reached, 1.48 g (0.009 mole) of para-toluenesulfonic acid monohydrate was added to the reactor and the temperature was increased to 160° C. At 160° C., vacuum was applied to the reactor and water was distilled off during 3 hours. Final acid value of the mixture was found to be 3.7 mg KOH/g.

The temperature was then reduced to 105° C. and the reactor was charged with 152.59 g (0.43 mole) of a branched fatty alcohol decyltetradecanol (ISOFOL 24 from Sasol) and then at 80° C. with 42.28 g (0.43 mole) of maleic anhydride. Another charge of para-toluenesulfonic acid monohydrate of 1.48 g (0.009 mole) was added to the reactor and the temperature was then increased to 160° C. Water was distilled off under vacuum during 5 hours 30 min. Final acid value was found to be 4.3 mg KOH/g. A sample was taken for GPC measurement in THF using a polystyrene calibration curve. Number molecular weight Mn was 1315 g/mol and average molecular weight Mw 3060 g/mol.

The reactor containing the polymer was cooled down to 80-85° C. and sulfitation was initiated by feeding into the reactor within 1 hour a solution of PH 7.0 composed of 220.0 g of tap water, 41.0 g (0.216 mole) of sodium metabisulfite and 25.0 g of 50% sodium hydroxide. After addition of the solution, the reactor was kept 2 hours at 80-85° C. Reactor was cooled down by adding 250.0 g of tap water.

A dark brown cloudy dispersion was obtained having a final solids content of 52% and a pH of 7.2.

Upon cooling at 20° C., the polymer dispersion became solid. Diluted to 35% solids after being heated up for 1 h at 65° C., the polymer dispersion became again solid after cooling at 20° C.

### Example According to the Invention: Polymer 1

A 1.5 liters reactor equipped with a thermometer, agitator and a cooling column connected to a vacuum pump was charged with 235.30 g (0.241 mole) of polycaprolactone diol (reaction product between neopentylglycol and ε-caprolactone monomer; CAPA 2100 from Ingevity with molecular weight of 976 g/mol) and 47.30 g (0.482 mole) of maleic anhydride and heated up to 120° C. After 2 hours, acid value was 94.8 mg KOH/g. The temperature was increased to 130° C. and then 200.0 g (0.482 mole) of a fatty alcohol polyethyleneglycol ether, based on iso-decanol and on average 5.5 EO units (BIODAC 510 from Sasol) was added to the reactor, immediately followed by the addition of 0.24 g (0.0014 mole) of para-toluenesulfonic acid monohydrate. When the temperature reached 130° C., temperature was held constant for 1 h and then vacuum was applied to the reactor and water was distilled off until acid value of the mixture was found to be lower than 5 mg KOH/g.

A sample was taken for GPC measurement in THF using a polystyrene calibration curve. Number molecular weight Mn was 2160 g/mol and average molecular weight Mw 5920 g/mol.

The reactor containing the polymer was cooled down to 60-65° C. and sulfitation was initiated by feeding into the reactor within 30 minutes a solution of pH 7.0 composed of 200.0 g of tap water, 45.80 g (0.241 mole) of sodium metabisulfite and 27.30 g of 50% sodium hydroxide. After addition of the solution, the reactor was kept 4 3 hours 30 min at 60-65° C. Reactor was cooled down by adding 1020.0 g of tap water.

A milky yellowish low viscous dispersion was obtained having a final solids content of 30.5% and a pH of 8.2.

Upon cooling at 20° C., the polymer dispersion was liquid.

### Example According to the Invention: Polymer 2

A 1.5 liters reactor equipped with a thermometer, agitator and a cooling column connected to a vacuum pump was charged with 208.80 g (0.236 mole) of polycaprolactone triol (reaction product between trimethylolpropane and &-caprolactone monomer; CAPA 3091 from Ingevity with MW 885 g/mol) and 67.10 g (0.236 mole) of stearic acid and heated up to 80° C. When the temperature had reached 80° C., 0.90 g (0.0052 mole) of para-toluenesulfonic acid was added and the reactor was further heated up to 130° C. After 2 hours at this temperature, the reactor was set under vacuum and water was distilled off during 3 hours. At this step, acid value was found to be 2.8 mg KOH/g.

The reactor was than cooled down to 80° C. and charged with 23.15 g (0.236 mole) maleic anhydride. After 2 hours reaction, acid value was 47.3 mg KOH/g.

A sample was taken for GPC measurement in THF using a polystyrene calibration curve. Number molecular weight Mn was 1830 g/mol and average molecular weight Mw 3030 g/mol.

The reactor containing the polymer was cooled down to 60-65° C. and sulfitation was initiated by feeding into the reactor within 30 minutes a solution of pH 6.8 composed of 100.0 g of tap water, 22.40 g (0,118 mole) of sodium metabisulfite and 13.80 g of 50% sodium hydroxide. After addition of the solution, the reactor was kept 3 hours 30 min at 60-65° C. Reactor was cooled down by adding 480.0 g of tap water. Final pH was adjusted with 14.0 g of 50% sodium hydroxide.

A turbid yellowish dispersion was obtained having a final solids content of 35.8% and a pH of 6.9.

Upon cooling at 20° C., the polymer dispersion was liquid.

### Example According to the Invention: Polymer 3

A 1.5 liters reactor equipped with a thermometer, agitator and a cooling column connected to a vacuum pump was charged with 208.80 g (0.236 mole) of polycaprolactone triol (CAPA 3091 from Ingevity with MW 885 g/mol), 67.10 g (0.236 mole) of stearic acid and 30.0 g (0.012 mole) of Tegomer C—Si 2342 from Evonik (a carboxylic dual end group polydimethylsiloxane having a molecular weight of approx. 2800 g/mol). The mixture was heated up to 80° C., 1.10 g (0.0064 mole) of para-toluenesulfonic acid was then added and the reactor was further heated up to 130° C. After 2 hours at this temperature, the reactor was set under vacuum and water was distilled off during 3 hours. At this step, acid value was found to be 2.8 mg KOH/g.

The reactor was than cooled down to 80° C. and charged with 23.15 g (0.236 mole) maleic anhydride.

After 2 h acid value was 44.8 mg KOH/g.

A sample was taken for GPC (Gel Permeation Chromatography) measurement in THF using a polystyrene calibration curve. Number molecular weight Mn was 1784 g/mol and average molecular weight Mw 2770 g/mol.

The reactor containing the polymer was cooled down to 60-65° C. and sulfitation was initiated by feeding into the reactor within 30 minutes a solution of pH 6.8 composed of 100.0 g of tap water, 22.40 g (0.118 mole) of sodium metabisulfite and 13.80 g of 50% sodium hydroxide. After addition of the solution, the reactor was kept 3 hours 30 min at 60-65° C. Reactor was cooled down by adding 520.0 g of tap water and 41.4 g of ethoxylated (55 EO) cetyloleyl alcohol surfactant. Final PH was adjusted with 11.0 g of 50% sodium hydroxide.

A turbid yellowish dispersion was obtained having a final solids content of 38.8% and a PH of 7.0.

Upon cooling at 20° C., the polymer dispersion was liquid.

### Example: Leather Application Protocols

All polymers from examples Polymer A and B, polymer 1-3 have been tested according to the application described below.

### Material

All applications have been performed on Wet blue upholstery leather with a thickness of 1.1-1.2 mm. Hides have been weighed. All raw material concentration is expressed in % based on shaved hide weight. For all examples, leather has been allowed to air dry by being toggled and finally milled.

### Retannage Process

### Washing

The hide was placed into a rotating steel drum filled up with 300% water and heated up to 40° C. 0.4% formic acid 85% was then added in the drum. The pH of the liquor was 3.2. The aqueous solution was then removed from the drum after 20 min rotation.

### Rechroming/Neutralization

150% water was added to the drum and heated at 40° C. 2% of Tannesco HN gran, a chromium containing retanning agent provided by TFL Ledertechnik AG, was added and the float was rotated for 30 min. The float was then neutralized respectively with 1.5% of sodium formate for 10 min followed by addition of 0.5% sodium bicarbonate for pH adjustment to 6.0. The drum was let rotate for 90 min. The aqueous solution was then removed from the drum and the hide was washed with 200% water at 30° C. for 10 min.

Retannage/Fatliquoring with the Polymers

100% water was added to the drum and heated to 35° C. 12% of SELLATAN RL, a synthetic phenol sulfonic acid syntan provided by TFL Ledertechnik AG, was added to the drum and the mixture was let rotate for 60 min. 1.2% Formic acid 85% was then added, rotation was continued for 30 min. Final pH was 4.0.

The aqueous solution was then removed from the drum and the hide was washed with 200% water at 30° C. for 10 min.

In order to visually inspect and compare the polymer performance in heat ageing fastness and COD, the leathers were not dyed but directly fatliquored with the different polymers from the above examples.

The fatliquoring was performed by adding into the drum 200% water, heating at 50° C. and then adding 5.6% polymer based on solid content. The mixture was let rotate for 90 min. Final fixation was made adding between 1.0% to 2.0% formic acid 85% (depending on the final PH obtained after the 90 min fatliquoring) and rotating for 30 min. Final pH is 3.5.

### Final Washing

After these different steps, the drum was drained off, ca. 250 g sample of the float was taken for COD measurements and the hide was then washed out with 200% water at 25° C. for 10 min.

### Evaluation of Polymer Effect on Leather Properties

The effect of the different fatliquoring polymers has been tested for different leather properties including softness, fullness, grain tightness and milling break. If softness after milling can be measured using a ST300 softness tester apparatus (RWD Bramley|BLC Research), fullness, grain tightness and milling break were evaluated subjectively by three persons using an arbitrary scale.

Ageing behavior of leather samples fatliquored with different polymers has been evaluated based on change in color after accelerated ageing. Color changes of leather samples have been estimated visually by using the grey scale for assessing change in color according ISO 105-A02: October 2005 after 280 h exposure to xenon lamp (which has a emission wavelength profile close to day light) according the EN ISO 105-B02: September 2014 method and 144 h heat exposure at 120° C. according to the EN ISO 17228: March 2015 method. For these two methods, the higher the values, the lower the yellowing and thus better the light and heat fastness.

Because it is nowadays requested that vehicle upholstery leather exhibits low emission characteristics, emission of volatiles from the fatliquored leather has been evaluated according two methods.

The first method measures the fogging characteristics of leather samples exposed at 100° C. using the DIN ISO 17071: September 2006 method A (which determines by reflection the light scattering properties or opaqueness and the nature of the film or droplet formation from volatile components condensed on a cold glass surface during 3 h at 21° C.) and method B (which measures gravimetrically the quantity of volatile components condensed on a cold aluminium foil surface during 16 h at 21° C.). The results obtained with the reflectance test (method A) are reported in percentage; the higher the value, the lower the fogging. Results obtained with the gravimetric test (method B) are reported in mg. The lower the value, the lower the fogging in this case.

The second method measures the emission of volatile or semi-volatile chemicals and is the VDA 278 which uses the thermal desorption analysis.

VDA 278 analytical method is intended for the determination of emissions from non-metallic materials used for molded parts in motor vehicles such as: textiles, carpets, adhesives, sealing compounds, foams, leather, plastic parts, films and sheets, paints or material combinations. The materials are characterized with regard to the type and quantity of the organic substances out gassed from them. In this method, two semi-quantitative cumulative values expressed in μg/g are determined which allow the emission of volatile organic compounds (VOC) and the portion of condensable substances also called semi-volatile fogging compounds (FOG) to be estimated. Furthermore, single substance emissions are determined. During the analysis, the samples are thermally extracted, and the emissions are separated by gas chromatography and detected by mass spectrometry (VDA-Recommendations, 1 May 2016).

Another important property to evaluate for new polymers is the degree of fixation after the fatliquoring process. This can be evaluated by measuring the chemical oxygen demand (COD). COD can be determined photometrically using the NANOCOLOR® COD 10000 REF: 985023 method, also equivalent to the methods EPA 410.4, APHA 5220D, DIN ISO 15705-H45 and DIN 38409-H41-1.

This test is suitable for water, wastewater and sludge after leather tanning or fatliquoring and can measure COD values in the range 1.00-10.00 g/L O2 (method 0231) or 1000-10000 mg/L O2 (method 0232).

COD of the float after leather treatment with the inventive polymer 1 have been compared to commercial samples and comparative samples.

Results of these different synthesis, leather evaluations and measurements are collected in Table 1 and Table 2:

TABLE 1
Physical state of dispersion as a function of temperature.

| | | | Commercial | Commercial | | | |
|---|---|---|---|---|---|---|---|
| | Polymer A | Polymer B | (EVOCOR AV2) | (PRINOL PNO) | Polymer 1 | Polymer 2 | Polymer 3 |
| Solid content % | 35% | 35% | 80% | 40% | 30.5% | 35.8% | 38.8% |
| PH at 20° C. | 7.2 | 7.2 | | | 8.2 | 6.9 | 7.0 |
| Physical state | | | | | | | |
| at 20° C. | Solid | solid | liquid | liquid | liquid | liquid | liquid |
| at 2° C. | — | — | liquid | liquid | liquid | liquid | liquid |

Comparative examples polymer A and polymer B diluted at 35% solids are solids at 20° C. whereas polymers according inventive steps show the advantage of remaining liquid also at 2° C. Also given in comparison are two formulated commercial polymeric fatliquors Evocor AV2 from CORICHEM and PRINOL PNO from Zschimmer and Schwarz. The fact that inventive polymers are liquids at low temperature will allow their use without further formulation to keep them liquid at low temperatures. Most customers do not accept fatliquors which show crystallization at low temperature and want to avoid heating up solidified products.

TABLE 2
Leather evaluations and measurements.

| | | | Commercial | Commercial | | | |
|---|---|---|---|---|---|---|---|
| | Polymer A | Polymer B | (EVOCOR AV2) | (PRINOL PNO) | Polymer 1 | Polymer 2 | Polymer 3 |
| Leather haptic | Soft but loose | Soft but loose | Tight, soft | Tight, soft | miling break good | Tight, soft | Tight, very soft |
| | bad miling | bad miling | full, good | miling break | Tight, full | full, good | full, good |
| | break | break | break | good | | break | break |
| ST300 softness | 5.1 +/− 0.3 | 5.4 +/− 0.2 | 4.0 +/− 0.2 | 6.5 +/− 0.2 | 4.0 +/− 0.1 | 6.5 +/− 0.2 | 7.1 +/− 0.3 |

Grey scale Change in color after accelerated ageing (visual)

| | | | | | | | |
|---|---|---|---|---|---|---|---|
| EN ISO 105-B02 | | | | | | | |
| Xenon 120 h | 4-5. | 4-5. | 4 | 4-5. | 4 | 4 | 4 |
| EN ISO 17228 | | | | | | | |
| 144 h 120° C. | 3-4. | 3-4. | 2 | 3-4. | 3 | 3-4. | 4 |

Fogging DIN ISO 17071

| | | | | | | | |
|---|---|---|---|---|---|---|---|
| Gravimetry (mg) | | | | | | | |
| 100° C./21° C. 16 h | | | | 3.5 | | 1.1 | 1.8 |
| Reflectance % | | | | | | | |
| 100° C./21° C. 3 h | 90.1 | 90.5 | 27.4 | 88.2 | 88.1 | 92.0 | 91.0 |

Emission according VDA278 (Thermal desorption analysis)

| | | | | | | | |
|---|---|---|---|---|---|---|---|
| VOC (μg/g) | 5 | 21 | 57 | 44 | 9 | 14 | 5 |
| FOC (μg/g) | 98 | 201 | 350 | 395 | 7 | 18 | 7 |

Chemical Oxygen Demand (NANOCOLOR ® COD 10000 REF: 9850232)

| | | | | | |
|---|---|---|---|---|---|
| COD (mg/L O2) | 3210 | 7410 | 4150 | 3650 | 2730 |

* Commercial formulation based on EP 33745129 state of the art

From the data in the Table 2, it is evident that, surprisingly, at least the FOC and COD values for Polymers according to the invention are superior when compared with the prior art.

1. Modified lactone polymers, obtainable by reacting, in the presence of a catalytic Lewis or Brønstedt acid reagent, a lactone oligomer or polymer—both referred to herein as lactone polymer having (A) at least two hydroxy or two amino groups or two carboxyl groups or (B) at least one hydroxy or amino group and at least one carboxyl group or (C) at least one hydroxy group and one amino group with at least
(1)—preceding reaction of an ethylenically unsaturated C4-C8 dicarboxylic anhydride—an alkyl or alkylene C12-C40 acid or alcohol, all of them being linear or branched, free or ethoxylated and/or propoxylated; an alkyl or alkylene C12-C22 primary or secondary amine that is linear or branched and is ethoxylated or not; a fatty C36 dimer or C54 trimer acid or alcohol or amine; a hydroxylated C12-C20 acid; or a fatty acid ester of glycerol, carrying hydroxyl or not; or two or more of these reactants; and optionally with branched alkyl C4-C10 alcohol or acid or amine and/or a polydimethylsiloxane with carboxylic or hydroxyl or amine end and/or side groups;
where the product of step (1) is then, when carrying
(a) no carboxyl group but at least one hydroxyl and/or amino group, or
(b) at least one carboxyl group and at least one hydroxyl and/or amino group, respectively,
(2) further reacted (i) with ethylenically unsaturated C4-C8 dicarboxylic anhydride or (ii) with phosphorus pentoxide, phosphoric acid or polyphosphoric acid, or (iii) a mixture thereof; where
(3) in the case of reacting with ethylenically unsaturated C4-C8 dicarboxylic anhydride, such as maleic anhydride or itaconic anhydride, the polymer of step (1) and/or step (2) is mandatorily, or where the polymer comprises at least one carboxyl group, further reacted with (i) metabisulphite, bisulphite, sulphite or sulfuric acid, or (ii) a mixture of two or more thereof;
with the proviso that the modified lactone polymer is,
where when starting from a lactone polymer (B) having one hydroxy and one carboxyl,
and where no preceding reaction with an ethylenically unsaturated C4-C8 dicarboxylic anhydride is performed,
in the case where only an alkyl or alkylene C12-C40 acid is reacted in step (1) or
in the case where an alkyl or alkylene C12-C40 acid and an alkylene C12-C40 alcohol are reacted in step (1), respectively,
other than the product of said lactone polymer (B) having resulted from ring opening with lactic acid.

2. The modified lactone polymers according to claim 1 in the form of an aqueous dispersion, obtained by dispersion of modified lactone polymers of claim 1 in water, optionally with or after neutralization by a base.

3. The modified lactone polymers according to claim 1, obtained by
reacting, in the presence of a catalytic Lewis or Brønstedt acid reagent, a lactone oligomer or polymer
(1*)—with preceding reaction of maleic or itaconic acid anhydride—with an alkyl or alkylene C12-C40 acid or alcohol that is free or ethoxylated and/or propoxylated;
where the product of step (1*) when carrying (a) no carboxyl group but at least one hydroxyl and/or amino group, or
(b) at least one carboxyl group and at least one hydroxyl and/or amino group, respectively,
(2*) further reacting with maleic or itaconic acid anhydride;
where
(3*) in the case of reacting with maleic or itaconic acid anhydride, the polymer of step (1*) and/or step (2*) is—where the polymer comprises at least one carboxyl group;
in the case where only an alkyl or alkylene C12-C40 acid is reacted in step (1) or
in the case where an alkyl or alkylene C12-C40 acid and an alkylene C12-C40 alcohol are reacted in step (1), respectively,
other than the product of said lactone polymer (B) having resulted from ring opening with lactic acid.

4. The modified lactone polymers or dispersion thereof according to claim 1, where the anhydride is maleic acid anhydride; and/or the lactone oligomer or polymer (A), (B) or (C) is the reaction product of a lactone monomer with a di- or polyol, a di- or polyamine or a di- or polyacid initiator, or a mixture of two or more thereof, that carries primary hydroxy or amine or carboxyl groups, respectively,
or the modified lactone polymers or dispersion thereof according to claim 1, where the anhydride is maleic acid anhydride; and/or the lactone oligomer or polymer is the reaction product of a lactone monomer with a di- or polyacid initiator, further reacted with a diamine or polyamine.

5. The modified lactone polymers or dispersion thereof according to claim 1, where the anhydride is maleic acid anhydride; and/or the lactone oligomer or polymer is a C4-C12 lactone oligomer or polymer, or a δ-valerolactone and/or an ε-caprolactone oligomer or polymer.

6. An aqueous composition comprising component (A**),
wherein (A**) comprises products (A**1), (A**2) or (A**3), or a mixture of two or all of them,
wherein
(A**1) is the reaction product of a lactone oligomer or polymer having (A) at least two hydroxy or two amino groups or two carboxyl groups or (B) at least one hydroxy or amino group and at least one carboxyl group or (C) at least one hydroxy group and one amino group;
(A**2) is the reaction product of (A**1), where said product has then when carrying
(a) no carboxyl group but at least one hydroxyl and/or amino group, or
(b) at least one carboxyl group and at least one hydroxyl and/or amino group, respectively,
been further reacted with (i) an ethylenically unsaturated C4-C8 dicarboxylic anhydride or (ii) with phosphorus pentoxide, phosphoric acid or polyphosphoric acid, or a mixture thereof; and
(A**3) is the reaction product of (A**1) or (A**2) when reacted with an ethylenically unsaturated C4-C8 dicarboxylic anhydride;
where the pH of the product is adjusted to a pH of 5 to 10.

7. The aqueous composition according to claim 6, wherein
(A1) is the reaction of the lactone oligomer or polymer (A), (B) or (C) with an alkyl or alkylene C12-C40 acid or alcohol that is free or ethoxylated and/or propoxylated;
(A2) is the reaction product of (A1), which when carrying
(a) no carboxyl group but at least one hydroxyl and/or amino group, or
(b) at least one carboxyl group and at least one hydroxyl and/or amino group, respectively,
has been reacted with with an ethylenically unsaturated C4-C8 dicarboxylic anhydride; and
(A3) is the reaction product of (A1) or (A2) if reacted with an ethylenically unsaturated C4-C8 dicarboxylic acid, especially maleic or itaconic acid anhydride, further reacted with metabisulphite, bisulphite, sulphite or sulfuric acid, or a mixture of two or more thereof;
followed by dispersion of the modified lactone polymers in water, with or after neutralization by a base to a pH of 5 to 10.

8. The aqueous composition according to claim 6, wherein the anhydride is maleic acid anhydride; and/or the lactone oligomer or polymer is the reaction product of a lactone monomer with a di- or polyol (preferred), a di- or polyamine or a di- or polyacid initiator, or a mixture of two or more thereof, that carries primary hydroxy or amine or carboxyl groups, respectively,
or the modified lactone polymers or dispersion thereof according to claim 1, where the anhydride is maleic acid anhydride; and/or the lactone oligomer or polymer is the reaction product of a lactone monomer with a di- or polyacid initiator, further reacted with a diamine or polyamine.

9. The aqueous compositions according to claim 6 where the anhydride is maleic acid anhydride; and/or the lactone oligomer or polymer is a C4-C12 lactone oligomer or polymer, or a δ-valerolactone and/or an ε-caprolactone oligomer or polymer.

10. A fatliquor for the treatment of leather comprising a modified lactone polymer according to claim 1 and one or more additives for stabilizing, coloring, softening, hydrophobisation, conservation and/or other conditioning.

11. The fatliquor according to claim 10, comprising an agent selected from the group consisting of phenol sulfonic syntan, acrylic polymer solution or dispersion, a sulphited or sulphated oil like rapeseed oil, fish oil, sunflower oil, soybean oil, linseed oil, cottonseed oil or palm oil, a mixture of two or more of them; and a silicone, or a polydimethylsiloxane oil or a polydimethylsiloxane emulsion or a reactive functional siloxane or a low molecular weight siloxane.

12. A method of fatliquoring of a skin or leather comprising applying a modified lactone polymer according to claim 1 the skin or leather.

13. The method according to claim 12, where the leather is a chrome and/or vegetable and/or aldehyde tanned leather.

14. A process for fatliquoring a skin or leather, comprising administering a fatliquoring agent comprising a modified lactone polymer according to claim 1 to said skin or leather in the presence of water and treating the resulting aqueous mixture at an elevated temperature from 30 to 80° C.

15. A leather obtainable by a manufacture comprising the process according to claim 12.

16. A process for the manufacture of a fatliquoring agent, comprising the process steps mentioned in claim 1.
